(19) United States
(12) Patent Application Publication
(10) Pub. No.: US 2017/0094289 A1
(43) Pub. Date: Mar. 30, 2017

(54) Dynamic Control of Pixel Color Formats Used to Encode Color Video Streams

(71) Applicant: Lattice Semiconductor Corporation, Portland, OR (US)

(72) Inventor: William Conrad Altmann, San Jose, CA (US)

(21) Appl. No.: 14/868,985

(22) Filed: Sep. 29, 2015

(51) Int. Cl. H04N 19/40; H04N 21/4402; H04N 19/182; H04N 21/2343

(52) U.S. Cl. CPC H04N 19/40; H04N 21/234309; H04N 21/234345; H04N 21/23439; H04N 21/440218; H04N 19/182

(57) ABSTRACT

Embodiments of the present disclosure are related to dynamic control of pixel color formats. In one embodiment, more than one pixel color format is used to encode a single scene within a video stream. This may be done for various reasons. For example, the available transmission bandwidth may change, thus leading to a change in the pixel color format where the new pixel color format uses a different amount of transmission bandwidth. Alternately, different regions within a scene may be encoded using different pixel color formats due to differences in their content. A highly detailed, vibrantly color region may be encoded using a richer color space and more bits per pixel, while a flat monotone region may be encoded using a pixel color format with fewer bits per pixel.

### BACKGROUND

1. Field of the Disclosure

This disclosure pertains in general to data communications, and more specifically to the transmission of color video streams.

2. Description of the Related Art

Video accounts for a significant fraction of all data communications and the vast majority of video is in color. In addition, the total volume of video transmission is increasing over time. More sophisticated functions are also being developed, such as embedding one video within another or displaying several video streams simultaneously on a single display. All of these lead to a greater consumption of transmission bandwidth and more complexity and variation in that consumption.

However, the color encoding of video is fairly static and inflexible. Color video streams are typically represented by a series of frames, each of which is made up of individual color pixels. Each color pixel typically is encoded as a certain number of bits, as defined by whichever pixel color format is selected for that video. The number of color pixels per frame and the frame rate might vary significantly from one video stream to the next, as might the number of bits used to encode individual color pixels. There are also many different color spaces that can be used to encode individual color pixels. However, usually only a single pixel color format is selected for any given video stream and all color pixels are then encoded using that pixel color format.

As a result, there is a need for improvements in color encoding to support these trends in video transmission.

### SUMMARY

Embodiments of the present disclosure are related to dynamic control of pixel color formats. In one embodiment, more than one pixel color format is used to encode a single scene within a video stream. This may be done for various reasons. For example, the available transmission bandwidth may change, thus leading to a change in the pixel color format in order to accommodate the change in available transmission bandwidth. Alternately, different regions within a scene may be encoded using different pixel color formats due to differences in their content. A highly detailed, vibrantly colored region may be encoded using a richer color space and more bits per pixel, while a flat monotone region may be encoded using a pixel color format with fewer bits per pixel. The adjustment of pixel color formats can lead to increased flexibility in video transmission.

Other aspects include components, devices, systems, improvements, methods, processes, applications, computer readable mediums, and other technologies related to any of the above.

### BRIEF DESCRIPTION OF THE DRAWINGS

The teachings of the embodiments disclosed herein can be readily understood by considering the following detailed description in conjunction with the accompanying drawings.

FIG. 1 is a high-level block diagram of a system for data communications, according to some embodiments.

FIG. 2 is a block diagram of a computing device suitable for use as a source device or sink device of FIG. 1, according to one embodiment.

FIG. 3 is a diagram of a structure of a video stream suitable for transmission by the system of FIG. 1.

FIGS. 4, 5 and 6 are diagrams of a single scene that uses different pixel color formats, according to some embodiments.

FIGS. 7A-7C are diagrams illustrating the inclusion of data indicating pixel color format in video packets, according to some embodiments.

FIGS. 8A-8B are diagrams illustrating the inclusion of data indicating pixel color format in auxiliary packets, according to some embodiments.

FIG. 9 is a block diagram of a source, according to some embodiments.

FIG. 10 is a block diagram of an encoder, according to some embodiments.

### DETAILED DESCRIPTION

The Figures (FIG.) and the following description relate to various embodiments by way of illustration only. It should be noted that from the following discussion, alternative embodiments of the structures and methods disclosed herein will be readily recognized as viable alternatives that may be employed without departing from the principles discussed herein. Reference will now be made in detail to several embodiments, examples of which are illustrated in the accompanying figures. It is noted that wherever practicable similar or like reference numbers may be used in the figures and may indicate similar or like functionality.

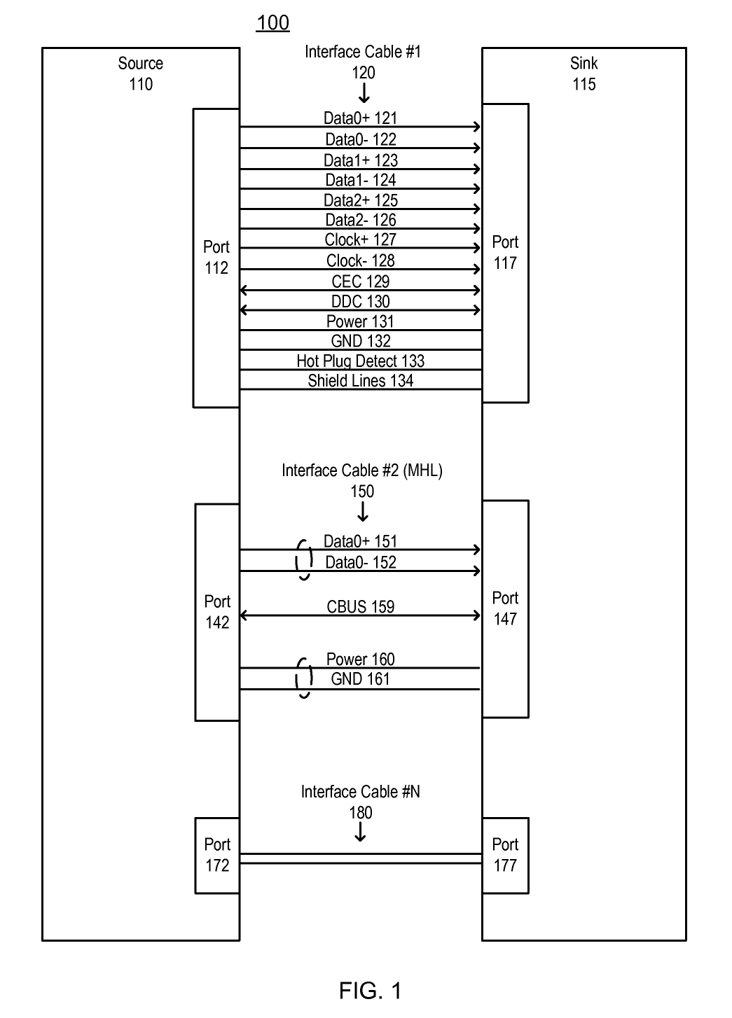

FIG. 1 is a high-level block diagram of a system 100 for data communications, according to one embodiment. The system 100 includes a source device 110 communicating with a sink device 115 through one or more interface channels, which are typically cables 120, 150, 180 as shown in FIG. 1 but could also be wireless or other channels. Source device 110 transmits multimedia data streams (e.g., audio/video/auxiliary streams) to the sink device 115 and also exchanges control data with the sink device 115 through the interface cables 120, 150, 180. In one embodiment, source device 110 and/or sink device 115 may be repeater devices.

Source device 110 includes physical communication ports 112, 142, 172 coupled to the interface cables 120, 150, 180. Sink device 115 also includes physical communication ports 117, 147, 177 coupled to the interface cables 120, 150, 180. Signals exchanged between the source device 110 and the sink device 115 across the interface cables pass through the physical communication ports.

Source device 110 and sink device 115 exchange data using various protocols. In one embodiment, interface cable 120 represents a High Definition Multimedia Interface (HDMI) cable. The HDMI cable 120 supports differential signals transmitted via data0+ line 121, data0− line 122, data1+ line 123, data1− line 124, data2+ line 125, and data2− line 126. The HDMI cable 120 may further include differential clock lines clock+ 127 and clock− 128; Consumer Electronics Control (CEC) control bus 129; Display Data Channel (DDC) bus 130; power 131, ground 132; hot plug detect 133; and four shield lines 134 for the differential signals. In some embodiments, the sink device 115 may utilize the CEC control bus 129 for the transmission of closed loop feedback control data to source device 110.

In one embodiment, interface cable 150 represents a Mobile High-Definition Link (MHL) cable. The MHL cable 150 supports differential signals transmitted, for example, via data0+ line 151, data0− line 152. Data lines 151 and 152 form a multimedia bus for transmission of multimedia data streams from the source device 110 to the sink device 115. In some embodiments of MHL, there may only be a single pair of differential data lines (e.g., 151 and 152). Alternatively, a plurality of differential data lines is provided to enable transmission (e.g., concurrently) of multiple differential signals on the multiple differential data lines. Embedded common mode clocks are transmitted through the differential data lines.

The MHL cable 150 may further include a control bus (CBUS) 159, power 160 and ground 161. The CBUS 159 is a bi-directional bus that carries control information such as discovery data, display identification, configuration data, and remote control commands. CBUS 159 for legacy MHL (MHL 1/2) operates in half duplex mode. On the other hand, CBUS 159 for MHL (MHL 3), alternatively referred to as an enhanced CBUS (eCBUS), operates in full duplex. In some embodiments, the eCBUS is single ended and provides single-ended signaling capability over a single signal wire. Alternatively, the eCBUS is differential ended (between differential lines eCBUS+ and eCBUS−) and provides differential-ended signaling capability over a differential pair of signal wires. An MHL 3 device (referred to herein as a local device) has the capability to interface with another MHL 3 device (referred to herein as a peer device) over a full duplex enhanced CBUS. For example, the source device 110 may be the local device if it is transmitting control information to the sink device 115. Alternatively, the sink device 115 may be the local device if it is transmitting control information to the source device 110.

Additionally, in the event that a local MHL 3 device communicates with a legacy MHL device over a legacy MHL link or to operate with legacy MHL software, the local MHL 3 device has the capability to downgrade to a legacy operational mode from the MHL 3 mode. For example, a local MHL 3 device has the capability to interface with a peer MHL 1/2 device over a half-duplex CBUS.

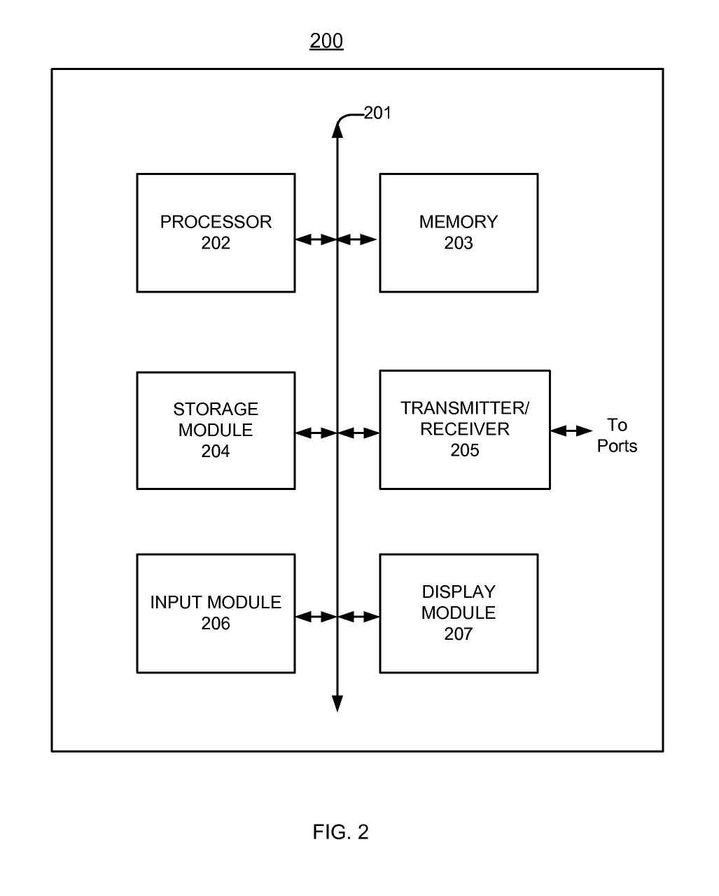

FIG. 2 is a detailed view of a device 200 suitable for use as the source device 110 or sink device 115 from FIG. 1, according to one embodiment. The device 200 can be, for example, a cell phone, a television, a laptop, a tablet, a desktop, a set-top box, a Blu-ray player, a DVD player, an A/V receiver, etc. The device 200 includes components such as a processor 202, a memory 203, a storage module 204, an input module (e.g., control panel on the device, remote control, keyboard, mouse, and the like) 206, a display module 207 (e.g. liquid crystal display, organic light emitting display, and the like) and a transmitter or receiver 205, exchanging data and control signals with one another typically through a bus 201.

The storage module 204 is implemented as one or more non-transitory computer readable storage media (e.g., hard disk drive, solid state memory, etc.), and stores software instructions that are executed by the processor 202 in conjunction with the memory 203. It may also store multimedia data such as video and audio. Operating system software and other application software may also be stored in the storage module 204 to run on the processor 202.

The transmitter or receiver 205 is coupled to the ports for transmission or reception of multimedia data and control data. Multimedia data that is received or transmitted may include video data streams or audio-video data streams or auxiliary data, such as HDMI and MHL data. The multimedia data may be encrypted for transmission using an encryption scheme such as HDCP (High-Bandwidth Digital-Content Protection).

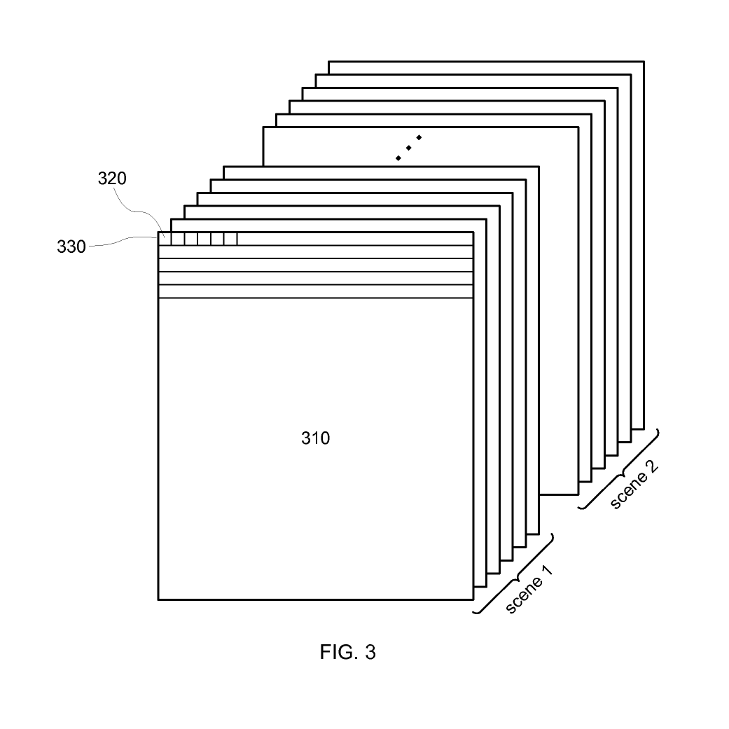

FIG. 3 is a diagram of a structure of a video stream suitable for transmission by the system of FIG. 1. The video stream includes different scenes. The scenes themselves are composed of video frames 310. Each large rectangle in FIG. 3 represents a video frame 310, and the stack of large rectangles in FIG. 3 represents a progression of video frames 310 which make up scenes 1 and 2. The progression of video frames is played back on a display device. Typical playback speeds are 30, 60 or 120 frames per second. Each video frame 310 is composed of color pixels 320, which typically are organized into lines 330. Terms such as standard definition (SD), high definition (HD), Ultra HD, 4K, 8K and the like define the number of pixels per frame.

In addition, to the number of pixels per frame, each color pixel is encoded using some encoding, which will be referred to as pixel color formats. Examples of pixel color formats include RGB 4:4:4, YCbCr 4:2:2 and YCbCr 4:4:4. Pixel color formats typically are defined by a color space (e.g., RGB, YCbCr), a color sampling rate (e.g., 4:4:4, 4:2:2, 4:2:0) and a color depth (e.g., 8 bit, 10 bit, 12 bit, 16 bit).

Embodiments of the present disclosure relate to systems, devices and methods where color pixels within a single scene are encoded using two or more different pixel color formats. For example, the pixel color formats may differ in color space, color sampling rate and/or color depth. Different encodings may be used due to transmission bandwidth factors. Reducing the color sampling rate or color depth reduces the required transmission bandwidth. Conversely, scenes with more detail may benefit from the use of pixel color formats which support the capture of more detail, but typically at the expense of requiring a higher transmission bandwidth. In another aspect, one or another color space may be more suitable, depending on the content of the video.

Systems where the pixel color format may be dynamically adjusted, for example in response to a changing transmission environment, allow more flexibility and optimization of the video transmission. In addition, finer granularity in the adjustment, for example if pixel color format is adjustable on a per-pixel or per-packet or per-line basis rather than on a per-frame basis, also results in more flexibility and freedom for optimization.

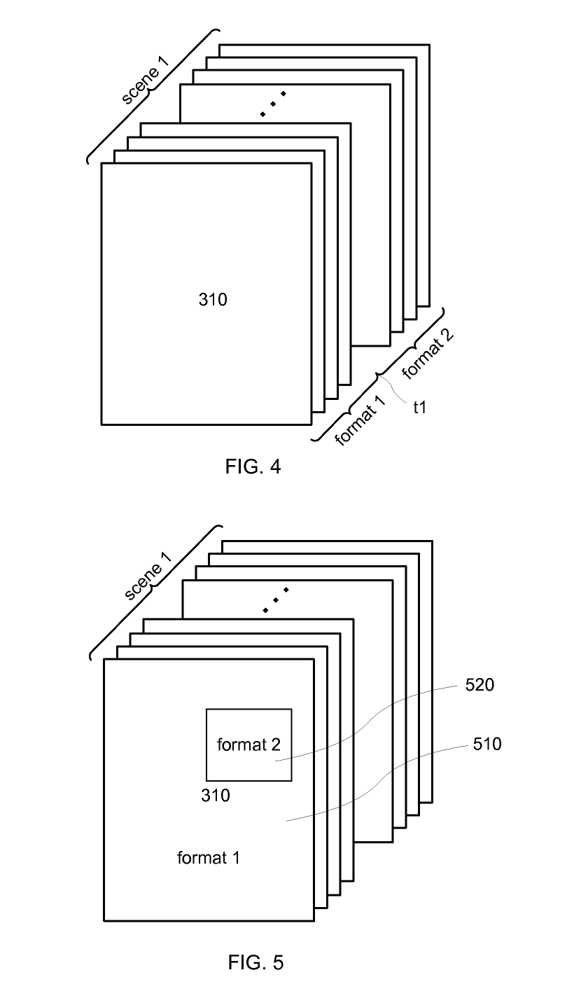

FIGS. 4, 5 and 6 are diagrams of a single scene that uses different pixel color formats, according to some embodiments. In FIG. 4, the set of frames from the beginning of the scene are encoded using one pixel color format. At some time t1, the pixel color format is changed and the set of remaining frames are then encoded using this second pixel color format. For example, perhaps there is a change in available transmission bandwidth. Prior to time t1, more bandwidth is available and, at time t1, the available transmission bandwidth is reduced. Pixel color format 1 may be the original pixel color format for scene 1 which could be transmitted using the originally available bandwidth but not after the available transmission bandwidth is reduced. Pixel color format 2 may then be a version of pixel color format that requires less transmission bandwidth. If the available bandwidth is later increased, the pixel color format may be adjusted again to a version with more information but using more bandwidth.

As another example, perhaps there is a change in the power mode of the source or sink. Prior to time t1, the source is operating in a regular power mode and, at time t1, the source enters a low power mode. The pixel color format may be changed to a version that requires less power to process and/or transmit. This may in part be the result of a lower bandwidth for the pixel color format, but may also be the result of different amounts of processing required for different types of color encodings.

In FIG. 5, different parts of frame 310 are encoded using different pixel color formats. In this example, most of the frame (region 510) is encoded using pixel color format 1, but a small rectangular region 520 is encoded using a different pixel color format 2. Perhaps region 520 is an area that contains unusually deep color or colors that are difficult to render or significantly higher detail, so that a different color space or a higher number of bits per pixel would be beneficial. The reverse might also be true. Region 520 might be background of a fairly constant color with little detail. In that case, bandwidth could be conserved by using a pixel color format that requires fewer bits per pixel.

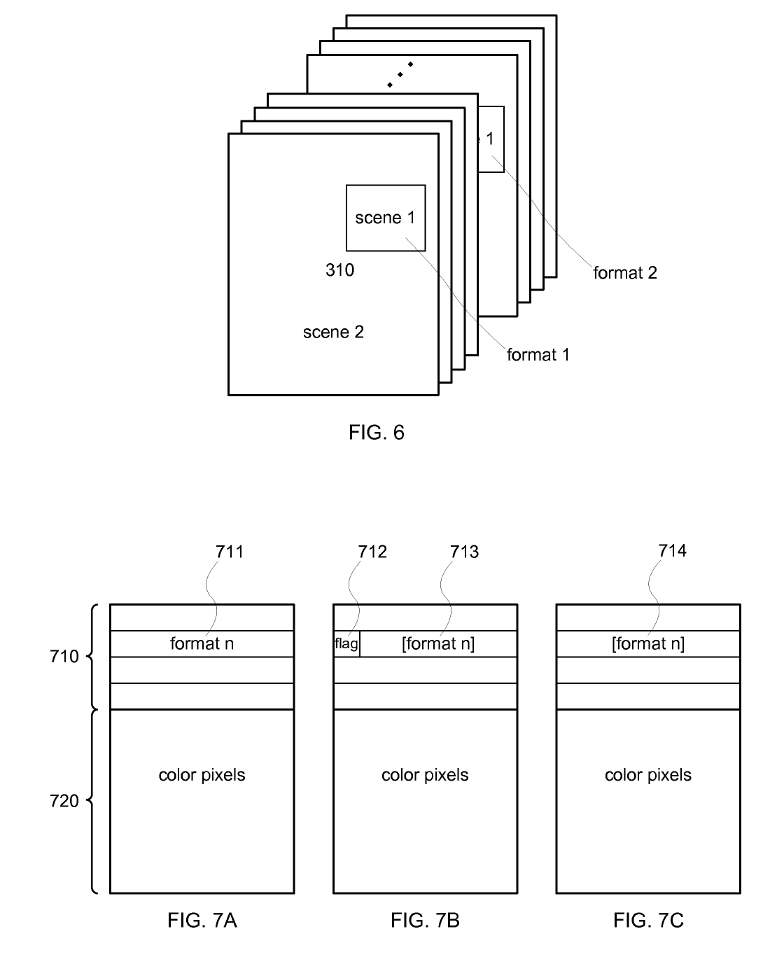

In FIG. 6, the overall video is a composite of different scenes. Scene 1 might be picture-in-picture, or it might be an advertisement framed within a larger scene. The pixel color format for scene 1 may be adjusted, for example in response to changes in scene 2. If scene 2 changes to require more transmission bandwidth, then the pixel color format for scene 1 may also be changed to reduce the bandwidth that it uses.

As another example, rather than having one scene within another scene, the video transmission may be a composite of multiple scenes which are displayed simultaneously. There might be a 2×2 arrangement of four different scenes. Pixel color formats may be adjusted in response to the transmission bandwidth used by the other scenes, including changes in the total number of scenes. If the number of scenes increases from two to three, but the available transmission bandwidth stays the same, then the available transmission bandwidth for each scene decreases.

FIGS. 4-6 are examples where different color pixels within a single video scene are encoded using different pixel color formats. The sink determines which pixel color format was used to encode which color pixels, so that the sink can correctly display the received color pixels. Typically, data indicating which pixel color format was used to encode which color pixels is also transmitted from the source to the sink. If the color pixels are transmitted in packets (which will be referred to as video packets), then this data typically indicates which pixel color format should be applied to which video packets.

In one approach, this data is included in the video packets themselves. FIGS. 7A-7C are diagrams illustrating the inclusion of data indicating pixel color format in video packets, according to some embodiments. Each of these figures shows a video packet, with the top part being a header 710 and the bottom part being the payload 720 which contains the color pixels. In FIG. 7A, every video packet includes data 711 identifying the pixel color format used to encode the color pixels in the payload. In this approach, each video packet can be processed independent of the other video packets, at least with respect to the pixel color format. If video packets are received out of order or if some video packets are dropped or lost, the remaining video packets can still be processed because the video packet itself identifies which pixel color format is used for its payload.

In FIG. 7B, the header contains a flag 712 and an optional field 713 for the pixel color format. In this approach, the video packets are ordered. The flag 712 indicates if the pixel color format for this video pixel is the same as that used for the immediately previous video packet. If it is, then the optional field 713 is not used or is ignored. If it is not, then the optional field 713 identifies the new pixel color format used for this video packet.

FIG. 7C is similar to FIG. 7B, except there is no flag 712. Rather, there is only an optional field 714 for the pixel color format. In one approach, if the pixel color format field 714 is used, that indicates the pixel color format for the video packet. Otherwise, the pixel color format is assumed to be the same as for the previous video packet. In an alternate approach, the pixel color format is assumed to be a default pixel color format unless field 714 is used.

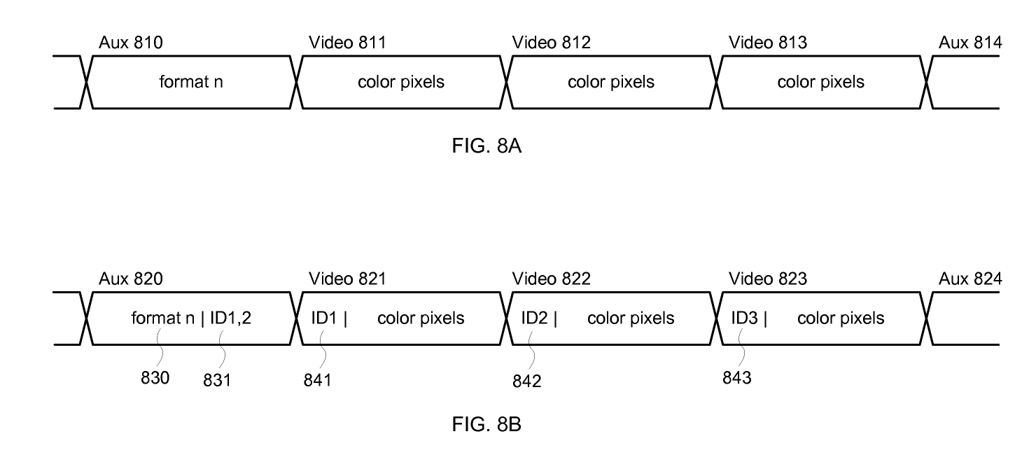

In a different approach, the data indicating which pixel color format is applied to which color pixels is not included in the video packets themselves. Rather, it is included in packets which do not contain color pixels (which will be referred to as auxiliary packets). FIGS. 8A-8B are diagrams illustrating the inclusion of data indicating pixel color format in auxiliary packets, according to some embodiments. FIG. 8A shows an auxiliary packet 810, followed by three video packets 811-813, followed by another auxiliary packet 814. Auxiliary packet 810 contains data identifying a pixel color format n. In the convention of this example, this means that pixel color format n was used for the following video packets, in this case video packets 811-813. Different conventions can be used. The convention might be that pixel color format n was applied to the N following video packets. It might be that format n was applied to all following video packets until another auxiliary packet 814 is received. It might be that format n was applied to all following video packets until another auxiliary packet indicates a different pixel color format.

In FIG. 8B, the auxiliary packet 820 includes both data 830 identifying a pixel color format n and data 831 identifying specific video packets. The delimiter|is used to separate the two data. Each video packet 821-823 also includes a packet identifier 841-843. In the auxiliary packet 820, data 831 indicates that the pixel color format n was applied to the video packets with packet identifiers ID1 and ID2. That is video packets 821 and 822, as indicated by their packet identifiers 841 and 842.

The examples shown in FIGS. 7-8 allow adjustment of the pixel color format at different levels of granularity. However, other approaches and other levels of granularity will be apparent. Depending on the need or application, pixel color formats may be adjustable on a per-pixel basis, on a per-packet basis, on a per-line basis, or for other groupings of pixels. For example, a scene may be divided into different spatial regions or into different blocks or macro-blocks, with different pixel color formats applied to each. Alternately, different pixel color formats may be applied to different objects in a scene.

As another example, in FIG. 7 the data indicating the pixel color format was included in the video packet containing the affected color pixels. In FIG. 8, the data was included in auxiliary packets, which do not contain color pixels. An alternate approach is to include this data in video packets, but not the video packets containing the affected color pixels. The data in one video packet might indicate the pixel color format for the color pixels contained in the next video packet, thus allowing the sink some lead time to process this information.

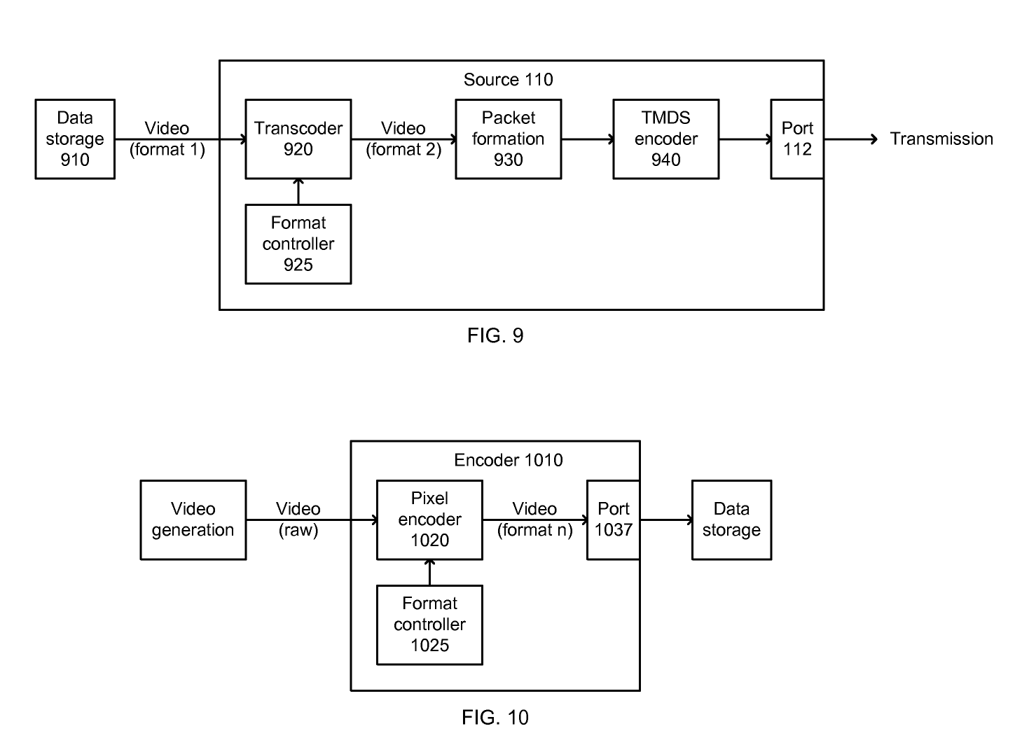

FIG. 9 is a block diagram of a source 110, according to some embodiments. In this example, the video stream comes from data storage 910. Examples include a source reading from a Blu-ray or DVD containing the video data, or from some sort of memory where the video data is stored. The video data is stored using pixel color format 1 and is originally provided to the source 110 in that format. A controller 925 dynamically determines whether to adjust the pixel color format. In FIG. 9, the pixel color format is changed from format 1 to format 2. Depending on the relationship between the two formats, a transcoder 920 may be used to effect the conversion. At other times, the controller 925 may determine to not change the pixel color format 1 or may change it to yet another pixel color format. The controller 925 may make these determinations dynamically in response to other information, such as available transmission bandwidth or sink decoding capabilities. Returning to the example of FIG. 9, the video data in pixel color format 2 is then packetized 930 and TMDS encoded 940. The video packets exit the source via port 112, where they are transmitted to the sink. Other processing typically will also be applied. The functionality of the source shown in FIG. 9 can be implemented in hardware circuitry, firmware, software or combinations of these.

FIG. 10 is a block diagram of an encoder, according to some embodiments. In this example, video data is originally generated. For example, it may be generated by capturing video of an event or it may be computer generated. The video data in its raw format is encoded 1020 according to a pixel color format determined by controller 1025. The controller 1025 may use two or more pixel color formats within a single scene. The video data is written to data storage for later playback. As with FIG. 9, for clarity, not all processing is shown in the figure.

Upon reading this disclosure, those of skill in the art will appreciate still additional alternative designs for dynamic control of pixel color formats. Thus, while particular embodiments and applications of the present disclosure have been illustrated and described, it is to be understood that the embodiments are not limited to the precise construction and components disclosed herein and that various modifications, changes and variations which will be apparent to those skilled in the art may be made in the arrangement, operation and details of the method and apparatus of the present disclosure disclosed herein without departing from the spirit and scope of the disclosure as defined in the appended claims.

What is claimed is:

1. A method for transmitting color video streams from a source to a sink, the method comprising:
transmitting, from the source to the sink, a plurality of color pixels; the color video streams comprising video scenes, each video scene comprising video frames, and the video frames comprising the transmitted color pixels; and
transmitting, from the source to the sink, data indicating the pixel color formats used to encode the transmitted color pixels, at least one of the video scenes encoded using two different pixel color formats.

2. The method of claim 1 further comprising:
encoding said video scene using two different color spaces.

3. The method of claim 1 further comprising:
encoding said video scene using two different color sampling rates.

4. The method of claim 1 further comprising:
encoding said video scene using two different color depths.

5. The method of claim 1 further comprising:
encoding one set of pixels within a frame from said video scene using one of the pixel color formats and encoding a different set of pixels within the same frame from said video scene using a different pixel color format.

6. The method of claim 1 further comprising:
encoding said video scene using a first pixel color format and, in response to a change in available transmission bandwidth, encoding said video scene using a second pixel color format that uses a different transmission bandwidth than the first pixel color format.

7. The method of claim 1 further comprising:
encoding said video scene using a first pixel color format and, in response to a change in a power mode for the source, encoding said video scene using a second pixel color format that uses a different amount of power for encoding than the first pixel color format.

8. The method of claim 1 further comprising:
packetizing the color pixels into video packets, the video packets including the data indicating the pixel color formats used to encode the color pixels.

9. The method of claim 8 wherein headers of the video packets include the data indicating the pixel color formats used to encode the color pixels.

10. The method of claim 8 wherein packetizing the color pixels comprises, for every video packet that includes color pixels, also including data indicating the pixel color format used to encode the color pixels contained in that video packet.

11. The method of claim 1 further comprising:
packetizing the color pixels into video packets, and
packetizing the data indicating the pixel color formats used to encode the color pixels into auxiliary packets that do not contain color pixels.

12. The method of claim 1 further comprising:
packetizing the color pixels into video packets, the data indicating the pixel color formats supporting the use of different pixel color formats to encode different individual video packets.

13. The method of claim 1 further comprising:
packetizing the color pixels into video packets, the data indicating the pixel color formats supporting the use of different pixel color formats to encode different groups of video packets.

14. The method of claim 1 wherein transmitting, from the source to the sink, a plurality of color pixels is performed according to a standard.

15. The method of claim 14 wherein transmitting, from the source to the sink, a plurality of color pixels is performed according to an MHL standard.

16. The method of claim 14 wherein transmitting, from the source to the sink, a plurality of color pixels is performed according to a standard that uses TMDS transmission of video data.

17. A source of color video streams, the source comprising:
a pixel encoder that receives a plurality of color pixels; the color video streams comprising video scenes, each video scene comprising video frames, and the video frames comprising the transmitted color pixels; the pixel encoder encoding the color pixels according to a pixel color format; and
a format controller coupled to the pixel encoder, the format controller specifying the pixel color format to the pixel encoder, the format controller specifying at least two different pixel color formats to encode different parts of at least one of the video scenes.

18. The source of claim 17 wherein the format controller specifies one of the pixel color formats to encode one set of pixels within a frame from said video scene and specifies a different pixel color format to encode a different set of pixels within the same frame.

19. The source of claim 17 wherein the pixel encoder and the format controller are implemented as an integrated circuit.

20. A method for receiving color video streams transmitted by a source to a sink, the method comprising:
receiving from the source, a plurality of color pixels; the color video streams comprising video scenes, each video scene comprising video frames, and the video frames comprising the received color pixels;
receiving from the source, data indicating the pixel color formats used to encode the received color pixels, at least one of the video scenes encoded using two different pixel color formats; and
decoding the received color pixels according to the pixel color format indicated by the received data.
